(19) United States
(12) Patent Application Publication
(10) Pub. No.: US 2014/0229618 A1
(43) Pub. Date: Aug. 14, 2014

(54) METHOD AND SYSTEM FOR CREATING A TEMPORARY SOCIAL NETWORK

(71) Applicant: LOBBYFRIEND, INC., Pointe-Claire (CA)

(72) Inventors: Mohit Kumar, Pointe-Claire (CA); Sonam Devgan, Waterloo (CA); Jason Ayoub, Montreal (CA)

(73) Assignee: LOBBYFRIEND, INC., Pointe-Claire (CA)

(21) Appl. No.: 13/762,993

(22) Filed: Feb. 8, 2013

(51) Int. Cl. H04L 12/24

(52) U.S. Cl. CPC H04L 41/00
USPC 709/225

(57) ABSTRACT

There is described a method for providing a user with a temporary access to a social network, comprising: receiving, from a user machine, an activation code comprising temporal information from which a temporary access period during which the user is allowed to access a social network platform is determinable; validating the activation code; determining, from the activation code, an end point in time at which an access of the user to the temporary social network ends; upon successful validation, providing the user with access to the social network platform until the end point in time is reached; and starting from the end point in time, preventing the user from accessing the social network platform.

### CROSS-REFERENCE TO RELATED APPLICATIONS

This is the first application filed for the present invention.

### TECHNICAL FIELD

The present invention relates to the field of platforms for social networks, and particularly temporary social networks.

### BACKGROUND

Social media such as social networks may help companies for marketing purposes. For example, a company such as a hotel may create a social network to which customers may subscribe. The hotel may then interact directly with its customers, launch advertising campaigns, analyze the behavior of its customers, etc. The customers who subscribed to the hotel social network may comprise past guests, future guests, and current guests. All of these guests may interact together via the hotel social network and the hotel may also interact with all of these guests.

However, a social network does not usually allow to discriminate between users so that only one group of users may interact together. For example, a hotel social network usually does not usually allow only current guests to interact together. Similarly, a social network does not usually allow an hotel to only connect with its current guests.

Therefore, there is a need for an improved method and system for creating a social network.

### SUMMARY

In accordance with a broad aspect, there is provided a method for providing a user with a temporary access to a social network, comprising: receiving, from a user machine, an activation code comprising temporal information from which a temporary access period during which the user is allowed to access a social network platform is determinable; validating the activation code; determining, from the activation code, an end point in time at which an access of the user to the temporary social network ends; upon successful validation, providing the user with access to the social network platform until the end point in time is reached; and starting from the end point in time, preventing the user from accessing the social network platform.

In one embodiment, the temporal information comprises the end point in time, said determining the end point in time comprising extracting the end point in time from the activation code.

In another embodiment, the temporal information comprises an access time duration.

In one embodiment, the step of determining the end point in time comprises calculating the end point in time using the access time duration and a given point in time at which said validating the activation code starts.

In a further embodiment, the temporal information comprises a start point in time starting from which the user is allowed to access the social network platform.

In one embodiment, the step of determining the end point in time comprises calculating the end point in time using the start point in time and a predefined time duration during which the user is allowed to access the social network platform.

In one embodiment, the method further comprises a step of generating the activation code.

In one embodiment, the step of validating the activation code comprises comparing the activation code to a list of previously generated activation codes.

In one embodiment, the temporary social network is adapted to connect together current guests of a hotel.

In one embodiment, the activation code is indicative of a country, a city, a hotel chain, a property identifier, a guest room number, a guest identifier, and a number of days of stay at the hotel in order to uniquely identify the guest.

In accordance with another broad aspect, there is provided a system for providing a user with a temporary access to a social network, comprising: a validation module for receiving, from a user device, an activation code comprising temporal information from which a temporary access period during which the user is allowed to access a social network platform is determinable, and validating the activation code; and an access control module for determining, from the activation code, an end point in time at which an access of the user to the temporary social network ends, upon successful validation of the activation code, allowing a connection between the user device and the social network platform until the end point in time is reached, and preventing the connection between the user device and the social network platform starting form the end point in time.

In one embodiment, the temporal information comprises the end point in time, the access control module being adapted to extract the end point in time from the activation code.

In another embodiment, the temporal information comprises an access time duration.

In one embodiment, the access control module is adapted to determine the end point in time using the access time duration and a given point in time at which said validating the activation code starts.

In a further embodiment, the temporal information comprises a start point in time starting from which the user is allowed to access the social network platform.

In one embodiment, the access control module is adapted to determine the end point in time using the start point in time and a predefined time duration during which the user is allowed to access the social network platform.

In one embodiment, the system further comprises a generating module for generating the activation code.

In one embodiment, the access control module is adapted to compare the activation code to a list of previously generated activation codes in order to validate the activation code.

In one embodiment, the temporary social network is adapted to connect together current guests of a hotel.

In one embodiment, the activation code is indicative of a country, a city, a hotel chain, a property identifier, a guest room number, a guest identifier, and a number of days of stay at the hotel in order to uniquely identify the guest.

A temporary social network is a social network to which users have a temporary access for a predetermined period of time or until a predetermined point in time. In one embodiment, the lifetime of the temporary social network may be indefinite, i.e. the temporary social network may last for an indefinite period of time, and the users have access to the temporary social network for a predetermined period of time or until a predetermined point in time. After the predetermined period of the time or starting from the predetermined point in time, the users have no longer access to the temporary social network. For example, the temporary social network may be created for guests of a hotel, and the guests have access to the temporary social network during their stay at the hotel. In this case, the temporary social network continues operating after a guest is prevented from accessing the temporary social network.

In another embodiment, the existence of the temporary social network itself may be temporary. For example, a temporary social network may be created for a conference which lasts for a predetermined period of time. The conference attendees may access the temporary social network for a time period which may be less or substantially equal to the lifetime of the temporary social network. In this case, the temporary social network created for the attendees of the conference may exist only during the conference. It should be understood that the lifetime of the temporary social network may be shorter or longer that the duration of the conference. For example, attendees may have access to the temporary social network starting from their registration to the conference until the end of the conference. In this case, attendees may interact together before the beginning of the conference. In another example, the temporary social network created for a conference may last for a predetermined period of time after the end of the conference so that attendees may continue interacting via the temporary social network after the end of the conference.

### BRIEF DESCRIPTION OF THE DRAWINGS

Further features and advantages of the present invention will become apparent from the following detailed description, taken in combination with the appended drawings, in which:

FIG. 1 is a flow chart of a method for providing a user with a temporary access to a social network platform, in accordance with an embodiment;

FIG. 2 is a flow chart of a method for allowing a user to register to a temporary social network, in accordance with an embodiment;

FIG. 3 is a block diagram of a system for creating a temporary social network, in accordance with an embodiment;

FIG. 4 illustrates an exemplary interface for displaying posts in a hotel temporary social network; and

FIG. 5 illustrates an exemplary interface for displaying deals in a hotel temporary social network.

It will be noted that throughout the appended drawings, like features are identified by like reference numerals.

### DETAILED DESCRIPTION

In the present detailed description, there is provided a method and system for creating a temporary social network, i.e. providing a user with a temporary access to a social network platform. The user is provided with an activation code for creating a user account on the temporary social network. The activation code may be user-specific or specific to a group of users. Furthermore, the activation code comprises temporal information from which a temporary access period during which the user is allowed to access a social network platform may be determined. The temporal information is hereinafter referred to as an access period of time during the user will have access to the social network platform. Upon successful verification of the activation code, the user is allowed to access the social network platform. The user may then subscribe to the temporary social network by creating a user account. Alternatively, the user first creates a user account, and is then prompted to input his activation code. Furthermore, the predetermined period of time during which the user has access to the social network platform is determined from the activation code. At the end of the predetermined period of time, the user has no more access the social network platform.

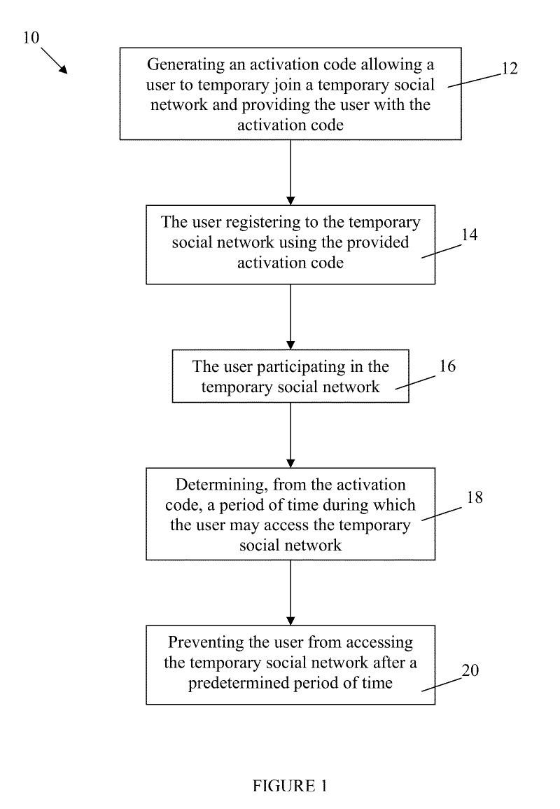

FIG. 1 illustrates one embodiment of a method 10 for providing a user with a temporary access to a social network platform. At step 12, an activation code is generated and provided to the user. The activation code is indicative of an access period during which the user may access the social network platform. Furthermore, the activation code may be user-specific so that two different users may not share a same activation code. Alternatively, the activation code may be specific to a group of users so that a same activation code may be shared by the users of the group. The generated activation codes are stored in memory for further validation of the activation codes inputted by the users.

In one embodiment, the activation code further comprises social network identification for identifying the temporary social network to which the user is provided access. For example, in the case of a hotel chain, the activation code may be indicative of the given hotel for which the user is a guest. The guest may then be directed to the appropriate temporary social network, i.e. the temporary social network corresponding to the given hotel.

In one embodiment, the access period during which the user may access the social network platform comprises a predetermined period of time that may be expressed as a time duration such as a number of months, weeks, days, hours, minutes, and/or the like during which the user may have access to the social network platform. For example, the access period of time may be equal to 24 hours. In this case, the user may have access to the social network platform for a time duration of 24 hours starting from a given start point in time. The start point in time may be the time at which he inputs his activation code during the registration to the temporary social network, the time at which he creates his user account, and/or the like.

In another embodiment, the access period during which the user may access the social network platform may be expressed as an end point in time. For example, the activation code may be indicative of a specific date and/or time starting from which the user is prevented from accessing the social network platform.

In a further embodiment, the access period during which the user may access the social network platform may be expressed as a start point in time. In this case, the time duration during which the user has access to the social network platform is predetermined and may be the same for all of the users. Alternatively, the users may be provided with different predetermined time duration during which they may access the social network platform. The end point of time starting from the user has no more access to the social network platform is determined using the start point in time contained in the activation and the predetermined access time duration. For example, in the case of a temporary social network created for attendees to a conference, all attendees may be provided with a same and fixed access duration during which they may access the temporary social network. For example, if the conference lasts three days, the access period for all attendees may be set to three days.

As described above, it should be understood that an indication of an access period contained in an activation code may be expressed as a time duration, a start point in time, and/or an end point in time. It should be understood that the activation code may also be indicative of a time duration and a start point in time, a start point in time and an end point in time, a time duration and an end point in time, or a time duration and a start and end point in time.

It should also be understood that any adequate information related to a time duration, a start point in time, and/or an end point in time may be used to define the access period. For example, a flight or train number may be used to define an access period. In the case of a temporary social network for users of an airport, passengers of a same flight may be provided with a same activation code to temporary access the airport temporary social network until the takeoff of their plane. In this case, the access period may be defined as the takeoff time for the plane. Alternatively, the access period may be defined by the flight number, and the takeoff time, which corresponds to the end point in time from which the passengers of the flight are prevented from accessing the airport temporary social network, may be retrieved from the flight number.

In one embodiment, an activation code comprises two parts, i.e. a first part being specific to a user or a group of users, and a second part that is indicative of the access period for the user. The following illustrates an exemplary activation code: “12343days”. In this case, the first activation code portion “1234” is user-specific so that no other user be provided with the same activation code portion. The second activation code portion, i.e. “3days”, is indicative of the access period, i.e. three days in the present example. It should be understood that the second portion of the activation code may also be indicative of an end point in time or a start point in time, such as in the following exemplary activation code: “123401122014”. In this case, the second portion of the activation code, i.e. 01122014, correspond to a date, i.e. Jan. 12, 2014, which may be either a start point in time or an end point in time. If the date is a start point in time, then the user may access the social network starting from that date for a predefined time duration which is known by the system. The end point in time may then be determined from the start point in time and the predefined time duration. For example, the time duration may be equal to 24 hours. In this case, the user will have access to the social network platform from 12:00 am on Jan. 12, 2014 to 12:00 am on Jan. 13, 2014. If the date is an end point in time, then the user may access the social network until that end date, i.e. until Jan. 12, 2014 at 12:00 am or 12:00 pm for example.

In one embodiment, the activation code is created in two steps. During a first step, a user-specific or group-specific code is created for a given user or a given group of users, respectively, and the user or group-specific code is unique so that any other user may be provided with the same user-specific code or any other user who is not part of the group may be provided with the same group-specific code, respectively. During a second step, the access period added to the user-specific code to form a single activation code for the user or group of users.

It should be understood that the activation code may be entirely or partially encoded. For example, a first portion of the activation code such as the user-specific code may be encoded while a second portion such as the portion corresponding to the access period may not be encoded. In another example, both the user-specific code and the access period portion of the activation code are encoded.

Referring back to FIG. 1 and once it has been created, the activation code is provided to the user at step 12. It should be understood that any adequate method for providing the user with the activation code. For example, the activation code may be sent to the user by email, text message, or the like. In another example, the activation code may be printed on a support such as a sheet of paper, a card, or the like. In a further example, the activation code may be displayed to the user on a display unit. In still a further example, the user may be provided with a device having Near Field Communication (NFC) capabilities. In this case, the activation code may be provided to the user via NFC communication.

At step 14, the user registers to the temporary social network using the received activation code. The user connects to the social network platform using a user device such as a computer, a smartphone, a tablet, or the like, and inputs the activation code. The server on which the social network platform is hosted receives the activation code and validates the activation code. Upon successful validation of the activation code, the user is provided with an access to the social network platform.

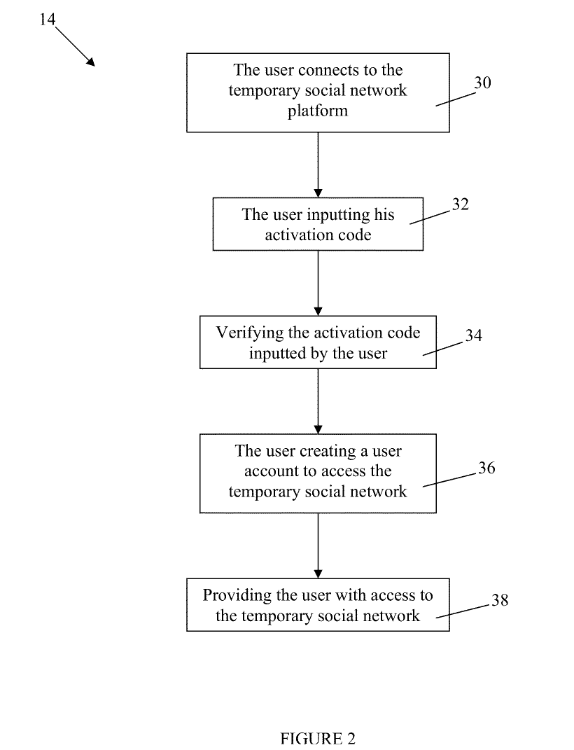

FIG. 2 illustrates one embodiment of the method 14 for allowing a user to register to the temporary social network using the activation code. At step 30, the user connects to the social network platform using any adequate user device. Once connected, the user inputs his activation code at step 32. The activation code is validated at step 34. It should be understood that any adequate method of validating an activation code may be used. For example, the activation code inputted by the user may be compared to a list of activation codes previously generated, and if the activation code inputted by the user corresponds to one of the previously generated activation codes, then a positive match is found and the activation code inputted by the user is validated.

In one embodiment in which an activation code comprises two portions, i.e. a user or group specific portion and a portion corresponding to the access period, only the user or group specific portion may be used for validating the activation code. Referring back to the previous example in which the generated activation code is “12343days”, then only the user or group specific portion, i.e. “1234”, is used for validating the activation code. For example, if the user or group specific portion “1234” matches one of the previously generated user or group specific code portions, then the activation code “12343days” is validated. In another embodiment, the whole activation code inputted by the user is used for the validation. For example, if it matches one of the previously generated activation codes, then the activation code “12343days” is validated.

In one embodiment in which the activation codes are at least partially encoded, the activation code inputted by the user is first decoded before being validated.

If the activation code inputted by the user is validated, the user is requested to create a user account, at step 36. For example, the user may be requested to input a username, a password, an email address, and/or the like. If the activation code inputted by the user is not validated, then the user is prevented from accessing the social network platform.

It should be understood that the user may be requested to create a user account before being prompted to input his activation code. In this case, the user account is first created, and the verification of the activation code is then performed.

Once the user account has been created, the user is directed to the social network platform and may use at least some functionalities offered by the temporary social network, at step 38.

It should be understood that, once the user account has been created, the user may access the temporary social network using some identifying information contained in his user account such as his username and his password. Therefore, the user is requested to input the activation code only once in order to create his user account. For all connection subsequent to the creation of the user account, the user connects to the social network platform via his username, his password, and/or the like.

Referring back to FIG. 1 and once he is connected to the social network platform, the user may participate in the temporary social network, at step 16. For example, the user may send messages to other users, create posts, receive messages or offers, receive advertising, and/or the like.

At step 18, the access period corresponding to the user is determined using the activation code inputted by the user. The access period may be directly extracted from the activation code or determined using information indicative of the access period and contained in the activation code.

In an embodiment in which the access period is defined as a predefined period of time during which the user may access the temporary social network, the end point in time from which the user is prevented from accessing the temporary social network is determined using the predefined period of time. For example, the end point in time may be determined from the point in time at which the user inputs his activation code or creates his user account, using the predefined period of time.

In an embodiment in which the access period contained in the activation code is defined as an end point in time, the end point in time is extracted from the activation code.

In an embodiment in which the access period contained in the activation code is defined as a start point in time, the end point in time is determined using the start point in time and a predefined time duration during which the user has access to the temporary social network.

At the end point in time, the user is prevented from accessing the social network platform, at step 20.

For each connection of the user to the social network platform subsequent to the first connection during which the user inputs his activation code and creates a user account, a verification of the permission for the user to access the temporary social network is performed. If the time at which the user requests the connection is anterior to the end point in time, then the user may access the social network platform. Alternatively, if the user requests access to the social network platform after the end point in time, the user is prevented from accessing the social network platform.

In one embodiment, the user account may be deleted and/or all interactions of the user with temporary social network may be deleted, after the end point in time. For example, all messages, posts, and/or the like sent to the user and/or received by the user may be deleted from the social network platform.

In one embodiment, the above-described method is embodied as an apparatus for providing a user with a temporary access to a social network platform. The apparatus comprises a storing unit, a communication unit, and a processing unit configured for executing the steps of the above method. It should be understood that the activation code may be generated by a first apparatus and the other steps of the method 10 may be performed by a second and different apparatus. Alternatively, all of the steps of the method 10 may be performed by a single apparatus.

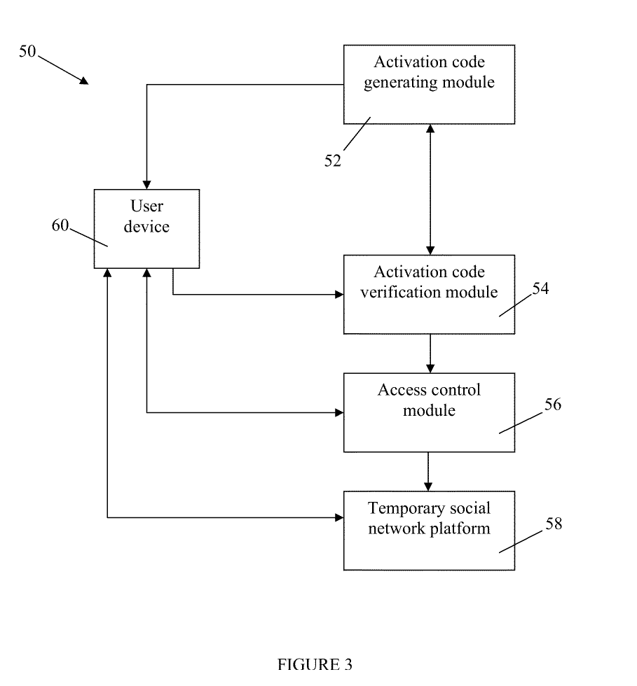

FIG. 3 illustrates one embodiment of a system 50 for creating a temporary social network. The system comprises an activation code generating module 52, an activation code validation module 54, an access control module 56, and a social network platform 58.

The activation code generating module 52 is adapted to generate an activation code for allowing a user to temporary access a social network platform. As described above, the activation code is indicative of an access period during which the user may temporarily access the social network platform. Furthermore, the activation code may be user-specific so that two different users may not share a same activation code. Alternatively, the activation code may be specific to a group of users so that a same activation code may be shared by the users of the group.

The activation code generating module 52 receives the access period for a given user or group of users, and generate the activation code using the received access period. For example, the access period may be inputted by an administrator or an employee of the temporary social network. In another example, the access period for each user may be stored in a database.

As described above, the access period may be defined as a time duration, a start point in time, and/or an end point in time. It should also be understood that any adequate information related to a time duration, a start point in time, and/or an end point in time may be used as to define the access period. For example, a flight number may be used as an access period, and the takeoff time for the flight, which corresponds to the end point in time from which the passengers of the flight are prevented from accessing the airport temporary social network, may be retrieved from the flight number.

As described above, an activation code may comprises two parts, i.e. a first part being user-specific or group-specific, and a second part that is indicative of the access period for the user or the group of users. In this case, an activation code may be created in two steps. During a first step, a user-specific code or a group-specific code is created for a given user or group of users, respectively. During a second step, the access period for the user or group of users is added to the user or group specific code to form a single activation code for the user or the group of users.

In one embodiment, the activation generating module comprises a user-specific or group-specific code generator and an access period integrating unit. The user-specific or group-specific code generator is adapted to generate the user-specific or group-specific code and transmit the user or group specific code to the access period integrating unit. The access period integrating unit further receives the access period for the user or the group of users and combines the user or group specific code and the access period together to form the activation code. In one embodiment, the user or group specific code generator and the access period integrating unit are part of a same module or device such as a same computer or server. In another embodiment, the user or group specific code generator and the access period integrating unit are physically independent from one another. For example, the user or group specific code generator may be part of a server while the access period integrating unit may be part of a computer that is remotely located with respect to the user or group specific code generator.

In one embodiment, the activation code generating module 52 is further adapted to encode the generated activation code.

As described above, any adequate method for providing a user with the activation code may be used. In one embodiment, the user is provided with a user device 60 adapted to communicate with the activation code generating module 52. In this case, the activation code may be sent from the activation code generating module 52 to the user device 60 via email, a Short Message Service (SMS), NFC communication, and/or the like. In another embodiment, the activation code generating module 52 may be connected to a display unit for displaying the generated activation code to the user. In a further embodiment, the activation code generating module 52 may be in communication with a printing for printing the activation code, and the printed activation code is provided to the user.

Furthermore, the activation codes generated by the activation code generating module 52 are stored in memory. The memory may be located on the activation code generating module 52, the activation verification module 54, or external to these two modules 52 and 54.

The user device 60 is adapted to transmit the activation code to the activation code verifying module 54. Upon reception of the activation code from the user device 60, the activation code verifying module 54 is adapted to validate the received activation code. For example, the activation code verifying module 54 may compare the activation code received from the user device 60 to the list of activation codes previously generated by the activation code generating module 52 and stored in memory. If the activation code verifying module 54 determines that the activation code received from the user device 60 corresponds to one of the activation codes previously generated by the activation code generating module 52, then a positive match is found and the activation code inputted by the user is validated by the activation code verification module 54.

In an embodiment in which an activation code comprises a user or group specific portion and a portion corresponding to the access period, the activation code verifying module 52 may extract the user or group specific portion from the received activation code and compare the user or group specific portion to user or group specific portions previously generated by the activation code generating module 52.

In an embodiment in which the activation codes are at least partially encoded, the activation code verifying module 54 is adapted to first decode the activation code before validation.

The activation code verifying module 54 is further adapted to transmit the activation code to the access control module 56. The access control module 56 is adapted to determine the access period for the user from the activation code. The access control module 56 may directly extract the access period from the activation code or determine the access period using information indicative of the access period and contained in the activation code.

In an embodiment in which the access period is defined as a predefined period of time during which the user may access the temporary social network, the end point in time from which the user is prevented from accessing the temporary social network is determined using the predefined period of time. For example, the end point in time may be determined, by the access control module 56, from the point in time at which the user inputs his activation code, using the predefined period of time.

In an embodiment in which the access period contained in the activation code is defined as an end point in time, the end point in time is extracted from the activation code by the access control module 56.

In an embodiment in which the access period contained in the activation code is defined as a start point in time, the access control module 56 is adapted to receive a predefined time duration during which the user has access to the temporary social network, and determine the end point in time using the start point in time and the predefined time duration.

Once the end point in time has been determined, the access control module 56 allows the user to create a user account. For example, the access control 56 may require the user to enter identification information such a username, his name, a password, an email address, and/or the like in order to create the user account. The user identification information is stored in memory along with the determined end point in time.

Once the user account has been created, the access control module 56 connects the user device 60 to the social network platform. The user may then participate in the social network, as described above.

As described above, it should be understood that the access control module 56 may be adapted to first allow the user to create a user account, and then prompt the user to input his activation code and verify the activation code.

The access control unit 56 is further adapted to monitor the connections of the user to the temporary social network. Once the user account has been created and when the user wants to connect to the temporary social network, identification information such as the user password and the user password are sent from the user device 60 to the access control module 56. The access control module 56 is adapted to authenticate the user using the received identification information and, upon successful authentication of the user, the access control module 56 retrieves the end point in time for the user from the memory. If the point in time at which the user wants to connect to the temporary social network, i.e. the point in time at which the identification information is received by the access control module 56, is anterior to the end point in time, then the access control module 56 connects the user device to the social network platform and the user may participate in the temporary social network.

If it determines that the point in time at which the user wants to connect to the temporary social network is posterior or substantially equal to the end point in time, then the access control module 56 does not connect the user device 60 to the social network platform and the user is prevented from accessing the temporary social network. Optionally, all activity of the user may be deleted from the social network platform starting from the end point in time.

In one embodiment, the above-described method and system may be used for creating a temporary social network for group-based operations in which the membership to a group is temporary in nature such as for users in a hotel, a cruise ship, a resort, a flight, a sporting event venue, a conference, a shopping mall, an airport lobby, a hospital, a public office, and/or the like. In this case, users may each have a temporary access only during the duration of their stay at their particular purpose at that venue. Each user may be provided with a unique activation code for accessing the temporary social network. The activation code is indicative of the access period during which the user may access the temporary social network. At the end of their stay, the users may be automatically removed from the temporary social network along with all their user activity from the social network platform throughout their stay.

In one example, a temporary social network connects an hotel (hotel staff/brand) to the guests of the hotel via web, hotel lobby TV, mobile apps, in-room TVs, etc. Guests are also connected to each other via the hotel temporary social network. The guests only have access to the temporary social network during their stay at the hotel while employees of the hotel and the administrator of the hotel temporary social network have a permanent access. At the end of their hotel stay, the users are automatically removed from the hotel temporary social network along with all their user activity throughout their stay. Each guest receives a unique activation code which is indicative of the duration of their stay at the hotel such as the number of nights they will stay at the hotel.

In one embodiment, the hotel is provided with pre-generated guest-specific codes to uniquely identify each guest. During the registration of a guest at the front desk, the number of nights that the guest will stay at the hotel is added to a given one of the pre-generated guest-specific code to form an activation code which is provided to the guest.

In one embodiment, an activation code is indicative of a country, a city, a hotel chain, a property identifier, a guest room number, a guest identifier, and a number of days of stay at the hotel in order to uniquely identify a specific guest in a specific hotel in a particular city of a particular country. For example, the activation code may comprise three digits for identifying the country, three digits for identifying the city, three digits for identifying the hotel chain, three digits for identifying the property identifier, four digits for identifying the guest room number, three digits for identifying the guest identifier, and two digits for identifying the number of days. In this case, the activation code comprises 21 digits. In one embodiment, an adequate hashing method may be used to reduce the size of the activation code. For example, the 21 digits activation code may be reduced to a seven digits activation code that is provided to the user.

Once generated, the activation code is provided to the guest. As described above, many different methods may be used for providing the user with the activation code.

For example, the activation code may be printed on a support at the front desk and the printed activation code is given to the guest. In another example, the activation code may be sent to a guest device via email, SMS, NFC communication, or the like.

In another example, all of the guests may be provided with a same access period. For example, the access period may be based on the average number of nights that guests stay at a given hotel. For example, the average number of nights may be equal to two nights for a given city hotel. In this case, all of the guests may be provided with a same two nights access period. In another example, the average number of nights may be equal to seven nights for a given resort. In this case, all of the guests may be provided with a same seven nights access period. When all of the guests are provided with a same access period, the activation codes may be integrated in the blogwall which is usually displayed in the lobby of the hotel. The activation codes may be displayed one by one. A guest desiring to register to the hotel temporary social network uses the activation code that is displayed on the blogwall. As soon as the activation code is validated, another activation code is displayed on the blogwall so that another guest may register to the temporary social network of the hotel.

In a further example, the system for creating a temporary social network may be integrated with or connected to the Property Management System (PMS) system of the hotel. All information about the guest such as his name, his room number, his check-in date, his expected check-out date, and/or the like, is stored in the PMS. The system for creating the temporary social network uses the information contained in the PMS for generating the activation code for the guest. For example, the PMS may transmit the expected check-out date to the temporary social network system that uses the expected check-out date as an end point in time for generating the activation code. The generated activation code is returned to the PMS which may display the activation code on a display unit located in the room of the guest.

Once provided with an activation code, the guest may start creating his user account by connecting to the hotel social network platform and inputting his activation code, as described above. In one embodiment, the user account may be created through another platform for which he already has a user account, such as Facebook™, Twitter™, LinkedIn™, or the like. In this case, user information such as his name, his email address, and/or the like, may be automatically transmitted from the already existing account, such as his Facebook™ account, to his temporary social network account. In this case, the guest may save time during the creation of his user account.

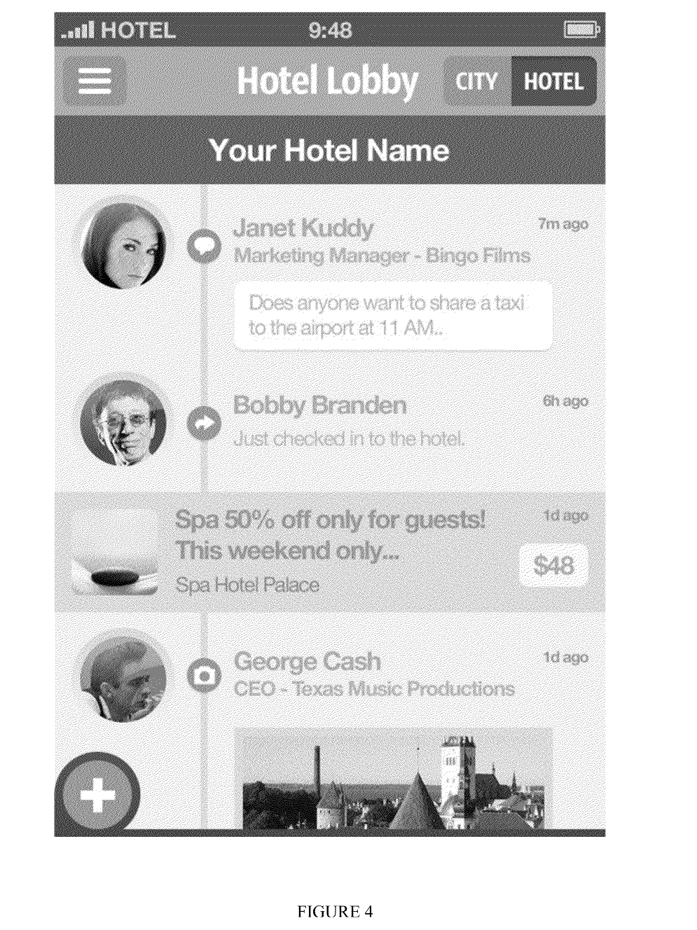

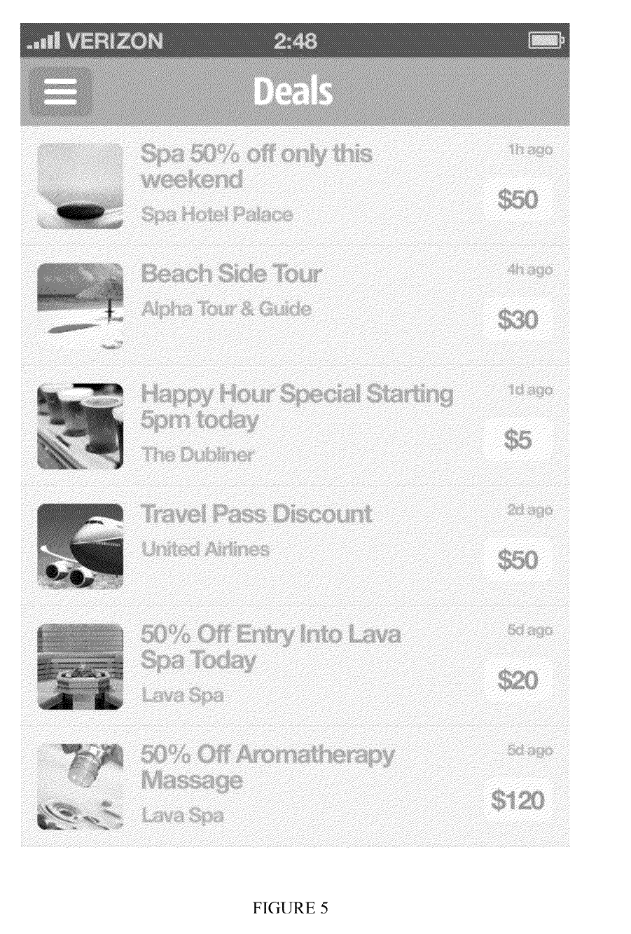

Once connected to the hotel temporary social network, a guest may send posts, reply to posts, and/or the like, as illustrated in FIG. 4. He may choose to browse and join deals or events posted on the temporary social network, as illustrated in FIG. 5. A guest may also send a private message to another guest of the same hotel or a hotel employee.

For example, the hotel temporary social network may provide the guests with the following functionalities:

ability to connect and interact with one another via private messages, instant chat function, general wall postings, commenting function, and/or the like;

ability to access the latest deals or offers posted by the hotel or brand or third party vendors;

ability to share travel pictures and videos in a feed;

ability to receive RSS feeds and Facebook™ and Twitter™ posts;

ability to share their social network activities on Twitter™ and Facebook™;

ability for guests to use a “Flag” option for bad posts and a “Like” option for preferred posts;

ability to access a city Lobby where all hotel temporary social networks available for a given city are connected on a bigger social network called a city Lobby;

ability for guests to set their status as online or offline;

ability to create and/or participate in events; and

ability to access a virtual city guide and offline maps that updates depending on the city in which the guest is.

For the hotel, the temporary social network provides the following functionalities:

ease of use for the hotel staff to post and update the temporary social network;

ability for hotel staff to prepare any deal, event, or message in advance to be automatically posted at a recurring pre-defined time in the future;

ability for hotels to customize their temporary social network design, look and feel to reflect their brand; and

ability for hotels to customize their features within their temporary social network (my hotel information, virtual concierge, booking engine, photo galleries, music, etc.).

In one embodiment, a temporary social network may be location-based. For example, access can be granted to guests that are physically at the hotel via Ground-Positioning System (GPS) information or geo-fencing technology. Another example would be based via the Wi-Fi, Ethernet, or Bluetooth connection at the venue where a user will be provided access based on the connection. When this connection expires, the user's access is revoked.

The embodiments of the invention described above are intended to be exemplary only. The scope of the invention is therefore intended to be limited solely by the scope of the appended claims.

I/We claim:

1. A method for providing a user with a temporary access to a social network, comprising:
receiving, from a user machine, an activation code comprising temporal information from which a temporary access period during which the user is allowed to access a social network platform is determinable;
validating the activation code;
determining, from the activation code, an end point in time at which an access of the user to the temporary social network ends;
upon successful validation, providing the user with access to the social network platform until the end point in time is reached; and
starting from the end point in time, preventing the user from accessing the social network platform.

2. The method of claim 1, wherein the temporal information comprises the end point in time, said determining the end point in time comprising extracting the end point in time from the activation code.

3. The method of claim 1, wherein the temporal information comprises an access time duration.

4. The method of claim 3, wherein said determining the end point in time comprises calculating the end point in time using the access time duration and a given point in time at which said validating the activation code starts.

5. The method of claim 1, wherein the temporal information comprises a start point in time starting from which the user is allowed to access the social network platform.

6. The method of claim 5, wherein said determining the end point in time comprises calculating the end point in time using the start point in time and a predefined time duration during which the user is allowed to access the social network platform.

7. The method of claim 1, further comprising generating the activation code.

8. The method of claim 1, wherein said validating the activation code comprises comparing the activation code to a list of previously generated activation codes.

9. The method of claim 1, wherein the temporary social network is adapted to connect together current guests of a hotel.

10. The method of claim 9, wherein the activation code is indicative of a country, a city, a hotel chain, a property identifier, a guest room number, a guest identifier, and a number of days of stay at the hotel in order to uniquely identify the guest.

11. A system for providing a user with a temporary access to a social network, comprising: a validation module for receiving, from a user device, an activation code comprising temporal information from which a temporary access period during which the user is allowed to access a social network platform is determinable, and validating the activation code; and an access control module for determining, from the activation code, an end point in time at which an access of the user to the temporary social network ends, upon successful validation of the activation code, allowing a connection between the user device and the social network platform until the end point in time is reached, and preventing the connection between the user device and the social network platform starting form the end point in time.

12. The system of claim 10, wherein the temporal information comprises the end point in time, the access control module being adapted to extract the end point in time from the activation code.

13. The system of claim 10, wherein the temporal information comprises an access time duration.

14. The system of claim 13, wherein the access control module is adapted to determine the end point in time using the access time duration and a given point in time at which said validating the activation code starts.

15. The system of claim 10, wherein the temporal information comprises a start point in time starting from which the user is allowed to access the social network platform.

16. The system of claim 15, wherein the access control module is adapted to determine the end point in time using the start point in time and a predefined time duration during which the user is allowed to access the social network platform.

17. The system of claim 10, further comprising a generating module for generating the activation code.

18. The system of claim 10, wherein the access control module is adapted to compare the activation code to a list of previously generated activation codes in order to validate the activation code.

19. The system of claim 10, wherein the temporary social network is adapted to connect together current guests of a hotel.

20. The system of claim 19, wherein the activation code is indicative of a country, a city, a hotel chain, a property identifier, a guest room number, a guest identifier, and a number of days of stay at the hotel in order to uniquely identify the guest.
